(19) United States
(12) Patent Application Publication
(10) Pub. No.: US 2026/0350874 A1
(43) Pub. Date: Nov. 5, 2026

(54) DYNAMIC MODEL INPUT CREATION FOR AI-AUGMENTED IMAGE GENERATION

(71) Applicant: Microsoft Technology Licensing, LLC, Redmond, WA (US)

(72) Inventors: Zeinab KAZEMI ALAMOUTI, Sunnyvale, CA (US); Youjun LIU, Palo Alto, CA (US); Rolly SETH, Redmond, WA (US); Brittany Elizabeth MEDEROS, Santa Clara, CA (US)

(21) Appl. No.: 19/195,874

(22) Filed: May 1, 2025

(51) Int. Cl. G06T 11/60; G06T 5/73; G06T 11/10

(52) U.S. Cl. CPC G06T 11/60; G06T 5/73; G06T 11/10; G06T 2200/24

(57) ABSTRACT

The disclosed technology includes a graphics design tool that to augments user-provided content with AI-generated graphics. The graphics design tool generates an AI-augmented graphics by operations that include: creating a content mask identifying areas of a user-provided image that include and exclude user-provided design elements; creating a graphics placement template based in part upon the content mask, the graphics placement template sized to match the user-provided image and including abstract shapes within areas of a frame that do correspond to the user-provided design elements; creating a noisy image by using an algorithm to add noise to the graphics placement template; providing a diffusion model with a set of model inputs that include the noisy image, the content mask, and an image modification instruction; receiving, from the diffusion model, an AI-generated image including AI-generated design elements; and creating the AI-augmented image by merging the AI-generated image with the user-provided image.

### BACKGROUND

A diffusion model is a type of generative artificial intelligence (AI) that creates data, like images, audio, or even video, by learning how to reverse noise into structure. A diffusion model starts with pure noise and gradually transforms the noise into something meaningful (like a photo) step by step.

Some modern graphics design tools include integrations that allow a diffusion model to create parts of a customized graphic that is being generated on behalf of an end user. When interacting with these tools, users typically want to retain a high level of control over the final design that is output by the diffusion model. For example, a user may want to provide the model with detailed text instructions that specify design details like placements, styles, colors, and more. Unfortunately, this user desire for a high level of control over AI-generated graphics is at odds with the limited capabilities of state-of-the-art diffusion models.

### SUMMARY

According to one implementation, a method for generating an AI-augmented graphic includes: receiving a user-provided image that includes user-provided design elements that are to be included in an AI-augmented image; creating a content mask identifying areas of the user-provided image that include and exclude the user-provided design elements; creating a graphics placement template based in part upon the content mask, the graphics placement template sized to match the user-provided image and including abstract shapes within areas of a frame that do correspond to the user-provided design elements; creating a noisy image by using a noisy algorithm to add Gaussian noise to the graphics placement template; providing a diffusion model with a set of model inputs that include the noisy image, the content mask, and an image modification instruction; receiving, from the diffusion model, an AI-generated image including AI-generated design elements; and creating the AI-augmented image by merging the AI-generated image with the user-provided image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that allows a user to create AI-augmented graphics.

FIG. 2A illustrates a first subset of example operations executed by a graphics design tool to dynamically generate inputs to a diffusion model in response to receiving user-provided design elements that are to be included in an AI-augmented graphic.

FIG. 2B illustrates another subset of example operations executed by the graphics design tool of FIG. 2A in response to the first subset of operations discussed with respect to FIG. 2A.

FIG. 3 illustrates example operations for generating AI-augmented images.

FIG. 4 illustrates an example computing device for use in implementing the described technology.

### DETAILED DESCRIPTION

State-of-the-art diffusion models have difficulty following certain types of input prompts pertaining to graphics and image generation. For instance, these models are often proficient at deciphering the general nature of subject matter identified in an input text prompt but far less proficient at following specific instructions pertaining to the placement of the requested subject matter. If, for example, a user asks for an image of “a cat on the left, a dog on the right, with a tree in the center,” it is not entirely uncommon for a diffusion model to render output with the correct subjects and incorrect placements. For example, the user might receive an image of a cat in a tree and a dog floating somewhere in space nearby.

To effectively leverage a state-of-the-art diffusion model as a tool for user-inspired designs (designs that reflect input from the user), it can be helpful to provide the diffusion model with supplemental inputs in addition to textual instructions. Providing an input image (e.g., sample or model image) is one way to help guide a diffusion model into creating the type of output that the user is looking for. If, for example, a diffusion model is provided with an input image and a textual instruction directing it to modify the input image in a particular way, the inclusion of the input image can help to anchor the structure of the output image being created by reducing randomness in terms of the type of content that the diffusion model creates. This, in turn, helps to make the final AI-generated content more predictable and controllable.

If, for example, a diffusion model is provided with an input image of the Van Gogh painting “Starry Night” and an instruction requesting that the image be modified to generate “a cyberpunk street in this style,” the image of “Starry Night” functions to guide the diffusion model in a way that creates a high likelihood that certain shapes, layout, colors, or forms from “Starry Night” will appear in the model output. Consequently, the output image in this example may depict a cyberpunk street with brushstrokes similar to Starry Night.

To help bridge the gap between the high level of control desired by users and the somewhat rudimentary instruction complexity that state-of-the-art diffusion models can follow reliably, graphics design tools that use back-end diffusion models tend to leverage techniques that entail passing supplemental inputs with each model prompt. Commonly, these techniques provide the diffusion model with some image-based input(s) in addition to text-based instructions. For example, a graphics design tool may be configured to provide a diffusion model with a background image that the model is to modify and potentially provide the user the opportunity to select this background image. In addition, some graphics design tools additionally leverage a technique referred to as masking. For instance, a binary mask can be used to tell a diffusion model where to place or not to place new image data relative to the frame of the background image. Effective utilization of mask inputs typically requires an advanced understanding of diffusion model parameters. For this reason, user-friendly graphics design tools tend to utilize pre-created masks that are selected and passed to the diffusion model without user input or knowledge.

The above-described background images and masks are commonly referred to as “blueprints.” A “blueprint” consists of a single background image and a single corresponding mask that—together—define a layout and placement of images, shapes, and/or text in a graphical design. The background image includes some graphical content that is to be modified by a diffusion model, while the mask indicates regions within the background image that are to remain unmodified or substantially unmodified. In graphics design tools that utilize blueprints, masks and images are designed in pairs-each mask is to be used with exclusively one background image and vice-versa. The purpose of the mask is to ensure that certain regions of the background image remain unmodified (e.g., creating free space for subsequently placing user-provided content) while other portions of the background image are modified by a diffusion model.

When interacting with a state-of-the-art graphics design tool that uses blueprints to guide the generation of graphical AI content, one approach is to provide the user with a library of pre-created background images and provide the user with the option to search for an image that possesses the set of characteristics that the user desires of the content they are trying to create. In another approach, a backend diffusion model is used to create design options for the end user with minimal user input. For example, the user enters text into a user interface (e.g., “create a banner for a new feature announcement”) and auto-generated AI-generated images are retrieved or dynamically created and then presented as suggestions to the users.

All of the above-described existing approaches generate the AI image designs by providing a diffusion model with a selection of one or more pre-created background images. Each pre-created background image is indexed in association with a corresponding mask, with the image-mask pair collectively representing the above-described “blueprint.” Per this approach, the selection of a background image automatically affects the selection of a corresponding pre-created mask, both of which are provided as inputs to a back-end diffusion model.

In addition to selection of the background image, which is performed by either the user or and application, the user may also identify specific content (e.g., text) that they want to include in the final graphic and provide a text-based image instruction that identifies features that the user desires in the final graphic. The background image, mask, user-specified content, and textual instruction are then passed to the diffusion model (sometimes after additional processing), and the diffusion model, in turn, modifies the background image in accordance with the text-based user instruction while omitting graphics in select areas identified by the mask. The user-provided content is subsequently merged into these areas of the AI-created graphic.

The above-described approach, which relies on pre-created blueprints to guide AI-assisted graphic design, has several shortcomings. First, it is cost-prohibitive from a design offering standpoint to provide large quantities (e.g., thousands) of background images, and it is common for a user to be unable to find a background image that conveys the style and/or color palette they are looking for. For example, the user might want an image that is more crowded, more sparse, or otherwise very different from available blueprints. In implementations that require the user to select a background image, it is inconvenient (time-consuming and onerous) for the user to scroll through hundreds or thousands of background images to look for one that most closely complies with their desired design. Oftentimes, a user is unable to find a suitable background image. In implementations that auto-select blueprints and present AI-generated design options to the user, the suggested designs often do not include the design characteristics that the user is looking for. The user may try, unsuccessfully, to manipulate the image(s) further, such as by providing the application with complex textual instructions that request design modifications that the diffusion model is not likely to understand. For example, a user might select a background image and type an image modification instruction that says: “Eliminate the red parts and move the blue and green shapes closer to the corner.” As mentioned above, diffusion models have difficulty following text-based placement instructions, and these types of instructions, therefore, tend to cause the model to fail to produce the modifications to the background image that the user desires.

Instead of providing the user with selectable pre-created blueprints to guide the creation of AI-generated visual data, the herein-disclosed graphics design tool dynamically creates a set of inputs to assist a diffusion model in performing image generation task at the time that the image generation task is requested or initiated by a user. The inputs to the diffusion model are generated based on one or more user-defined input parameters that identify characteristics of the graphical design that the user is seeking to create. In one implementation, the herein-disclosed graphics design tool dynamically creates an image—referred to herein as a “graphics placement template”—based on a set of user-defined input parameters. The graphics placement template includes abstract shapes at various locations within a frame-identifying areas that are to be populated with AI-generated design elements. Per this methodology, certain characteristics of the abstract shapes, such as placement and image “busyness” (discussed further below), are optionally dictated by the user-specified input parameters.

Once created, the graphics placement template is input to a noisy algorithm that modifies the graphics placement template by adding colored noise-thereby creating a “noisy image” that is, in turn, provided to a diffusion model along with an instruction directing the model to modify the noisy image in some way. In some implementations, a color scheme of the final AI-generated imagery is guided by (e.g., fixed to a high probability of compliance with) a user-selected color pallet that is used by the noisy algorithm to infuse the noisy image with the color noise before the noisy image is passed to the diffusion model.

Dynamically creating the noisy image in this way (that is, from a user-specified color pallet and graphics placement template that is itself dynamically created based on user-supplied input parameters identifying desired design characteristics) ensures that the generative AI process is governed by stylistic controls selected by the end user. When this methodology is employed, certain user-defined characteristics of the noisy image such as colors, graphics placement, and busyness factor, are carried over into and preserved within the AI-generated design elements generated from the noisy image.

When compared to state-of-the-art graphics design tools that leverage diffusion models for graphics augmentation, the herein-described methodology increases the likelihood of user success in causing the diffusion model to generate design elements that ultimately possess a set of aesthetic characteristics that are desired by the user. In contrast, state-of-the-art graphics design tools typically require the user to find a suitable pre-created image that possesses the desired aesthetic characteristics—a feat which is, in many cases, not possible due to the application's inability to consistently select blueprints that result in AI-generated images appealing to the user, to the limited number of available background (blueprint) images, or, instead, due to time constraints of the user that make it infeasible to conduct a thorough search of the image library (in cases where an image library is provided). In addition, the disclosed techniques also improve upon state-of-the-art graphics design tools by reducing development overhead (e.g., human effort) associated with creating libraries of user-selectable blueprints while simultaneously reducing storage overhead that is otherwise associated with storing the libraries that are, in the disclosed approach, unnecessary.

In still further addition to all of the above, the herein-disclosed techniques increase the quality of the user experience when interacting with a graphics design tool to generate AI-augmented graphics by eliminating the onerous step of blueprint selection, thereby simplifying the process and increasing user enjoyment and satisfaction.

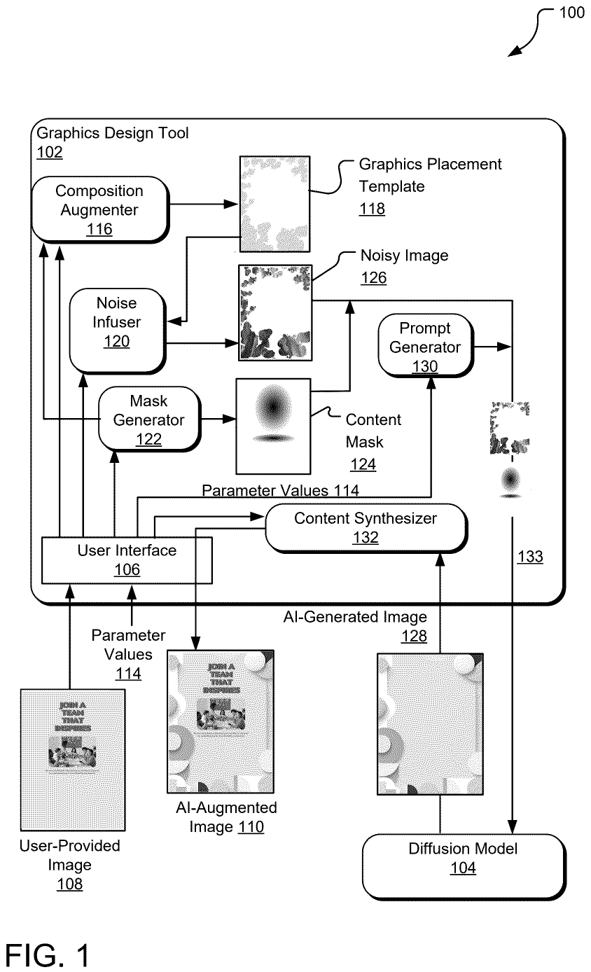

FIG. 1 illustrates an example system 100 that allows a user to create AI-augmented graphics. As used herein, the term “AI-augmented graphic” refers to image data that includes at least one AI-generated design element and at least one user-provided or user-created design element. The system 100 includes a graphics design tool 102 (e.g., software, executable by a processing system) that interfaces with a diffusion model 104 to create visual content that is guided, at least in part, by parameters set by an end user.

The diffusion model 104 is a generative AI model that creates or modifies images (and sometimes other data types like audio or 3D shapes) by gradually transforming random noise into a coherent output through a learned process. During a training process, the diffusion model 104 learns by gradually adding noise to real images and then learning how to reverse that process—essentially learning how to “undo” noise. Then, in image generation, the diffusion model 104 starts with random noise (e.g., the noisy image 126) and applies the reverse steps learned during training to turn the noise into a meaningful image. The diffusion model 104 is trained to perform “conditional generation” which refers to the capability of the model to render outputs guided by text prompts, image masks, reference images, or style instructions. Examples of publicly available diffusion models include Stable Diffusion, DALL·E 2, Imagen, and MidJourney.

The graphics design tool 102 is a graphics generation application that may be web-based (e.g., executed on a cloud server accessible to a user via the internet), locally executable on a user device, or distributed among two or more different computing devices that are remote, local, or some combination thereof with respect to the end user. The graphics design tool 102 includes control logic that, when executed by a processing system, presents a user interface 106 on a display (not shown). An end user interacts with the user interface 106 to initiate the creation of an AI-augmented image 110. Specifically, the end user interacts with graphical user interface (GUI) elements of the user interface 106 to supply (meaning, to create, identify, import, or any combination thereof) a user-provided image 108 that is to be included in the AI-augmented image 110. The user-provided image 108 has a defined frame boundary and some content—referred to herein as “user-provided design elements”—within that boundary. In various implementations, the user-provided design elements may include text, graphics, or any combination thereof.

The user-provided image includes may be created in various ways. For example, it is contemplated that the user may interact with the graphics design tool 102 to create the image, such as by creating an initial arrangement of the text (e.g., a text distribution with a particular alignment, using designated fonts, sizes, or colors) and/or to create or place graphics with respect to the frame such that the user-provided image108 constitutes a base “image”—e.g., content with specified placement within the frame. For example, the user interface 106 may provide UI controls that allow the user to create graphical elements from scratch (e.g., by inserting text, shapes, images, or by interacting with controls that manipulate such elements). In other implementations, the user-provided image 108 is a pre-created image imported into the graphics design tool 102. For example, the user identifies the user-provided image 108 by interacting with the user interface 106 to provide the location and name (e.g., file path) for the pre-created image.

In different implementations, the user-provided image 108 is being used to create different types of work products. For example, the user may be creating an event invitation, a brochure, infographics, a newsletter, education materials, a piece of promotional material (e.g., posters, flyers, advertisements), a company trademark, a website logo, etc. In the example shown, the user-provided image 108 includes an arrangement of text (e.g., a header of fixed size, font, and color), an image, and a capture below the image. It is contemplated that the arrangement may be created by any suitable method, including through interactions with external applications, manual creation (e.g., drawing and scanning), as well as through direct interactions with the user interface 106.

In addition to identifying the user-provided image 108, the user also interacts with the user interface 106 to set one or more parameter values 114 optionally. The parameter values 114 are also referred to herein as “user-selected input parameters” that function to anchor (fix) certain characteristics of an AI-generated design image 128 that is merged with the user-provided image 108 to create the AI-augmented image 110.

In different implementations, the user interface 106 provides the end user with controls that allow the user to select values of different selectable parameters, which are shown in FIG. 1 as “parameter values 114” input by the user to the user interface 105. In one implementation, the user interface 106 includes a control that allows the user to specify a placement instruction identifying one or more desired locations for AI-generated design elements to be added relative to existing design elements within the frame of the user-provided image 108. For example, the placement instruction may designate one or more frame subregions such as “top,” “bottom,” “left,” “right,” “all corners,” “all edges,” “top-right corner,” “top-left corner” “center,” “top-half,” “bottom-half,” “left one-third,” “right one-third,” etc.

In the same or another implementation, the user interface 106 provides the end user with an option to designate a desired “busyness factor.” As used herein, image “busyness” refers to the visual complexity or density of elements within the image. It describes how much is going on visually —how crowded, detailed, or cluttered the image appears.

In still other implementations, the user interface 106 provides the user with GUI elements for specifying a desired color pallet (e.g., one or more colors) for the AI-generated design elements or for designating a predefined “style” for the AI-generated design elements. Thus, in the following description, the parameter values 114 may be understood as including values set by the user that that identify characteristics that the user desires for the work product they are creating (the AI-augmented image 110). These characteristics identified by the parameter values 114 may include, but are not limited to, graphics placement, busyness, color, and style.

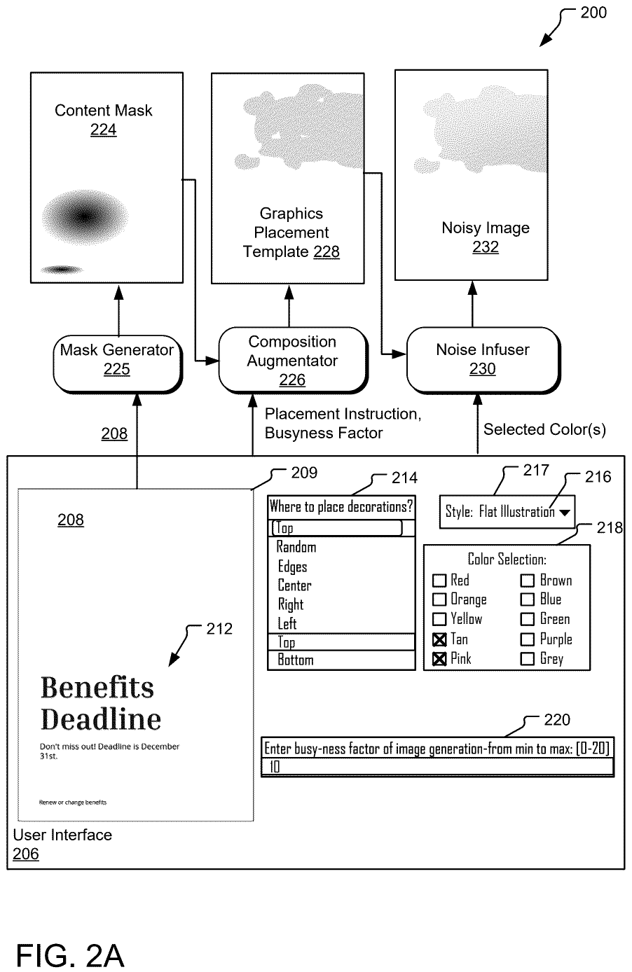

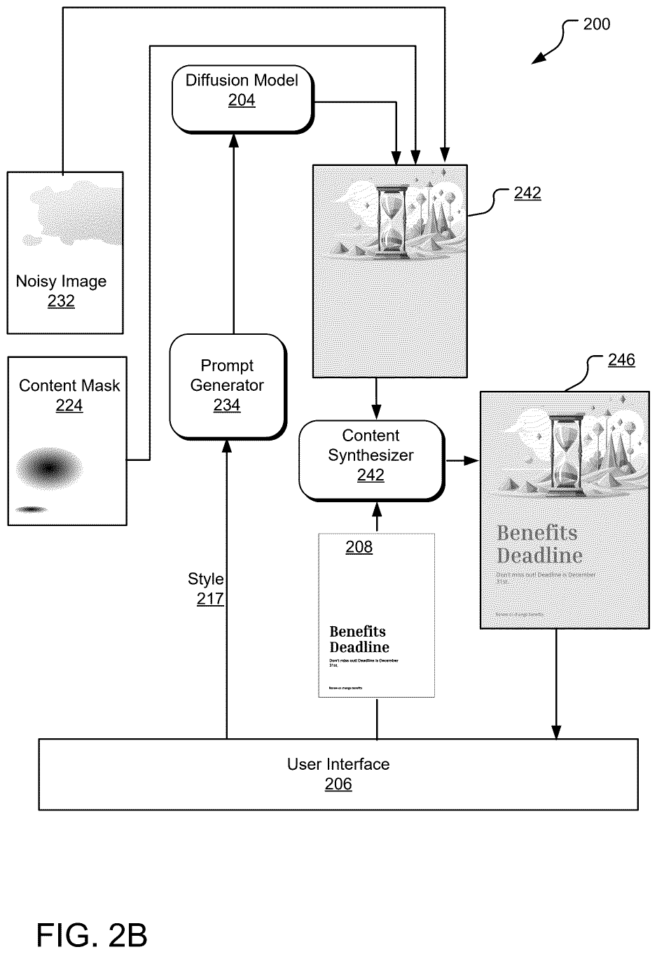

The graphics design tool 102 includes a mask generator 122 that receives, as input, the user-provided image 108 and processes the user-provided image 108 to generate a content mask 124 that identifies locations within the frame of the user-provided image 108 that do and do not contain design elements. When subsequently provided as an input to the diffusion model 104, the content mask 124 functions to inform the diffusion model 104 of a degree of modification (e.g., design element creation) that is permitted in each different region of an image frame (e.g., a frame with dimensions equal to the content mask 124). In some implementations, the content mask 124 is a binary mask that contains some regions filled with exclusively black pixels and other regions filled with exclusively white pixels. The black pixel regions identify areas where image modification is permitted, whereas the white pixel regions indicate areas where modification is not permitted. In other implementations, the content mask 124 is a binary gradient mask that intersperses black pixels with white pixels at relative densities indicative of a degree to which the diffusion model 104 is permitted to modify or create content. For example, some modification may be permitted in areas with higher black pixel density-e.g., areas overlapping or proximal to design elements within the user-provided image 108-whereas unrestricted modification may be permitted in areas that do not overlap with the user-provided design elements. The advantages of using these different types of masks are discussed further with respect to FIG. 2.

In addition to the mask generator 122, the graphics design tool 102 additionally includes a composition augmenter 116 that uses the content mask 124, in addition to some or all of the parameter values 114, to generate a graphics placement template 118 that functions to anchor or otherwise influence certain characteristics of AI-generated image 128 that are ultimately created by the diffusion model 104 based on the parameter values 114. The graphics placement template 118 functions to influence the selection of subregion(s) within the frame of the user-provided image 108 that are ultimately merged with the AI-generated image 128 as well as the “busyness” level (as defined above) of the AI-generated image 128 in those regions.

To generate the graphics placement template 118, the composition augmenter 116 first defines a frame that is of the same dimensions as the frame containing the user-provided image 108 and the same dimensions as the content mask 124. Then, the composition augmenter 116 selectively places abstract shapes of different forms (shapes) and sizes within this frame. The abstract shapes may, for example, be selected from a predefined library of shapes, such as a shape library used by other applications (e.g., abstract illustrations in Microsoft PowerPoint) or a library of SVG (scalable vector graphics) files that each define a different shape. The selection of each shape added to the graphics placement template 118 may be performed at random or using other suitable selection methods.

The placement of each abstract shape within the defined frame is guided by two placement objectives. The first one of these placement objectives is to avoid or mitigate overlap between the abstract shapes in the graphics placement template 118 and the positions of design elements within the frame of the user-provided image 108. In one implementation, shape placement is performed—at least in part—based on the content mask 124. For example, a location for a new shape is selected by randomly selecting a pixel to serve as the “seed” or centroid for each new shape, with the probability of each pixel being selected depending upon the value of the corresponding pixel (e.g., at the same location) in the content mask 124. For example, locations corresponding to black pixels in the content mask 124 (signifying overlap with user-provided content) may be excluded from the random selection pool entirely or selected with lower probability odds than white pixels (signifying empty space) since it is typically desirable to add AI-generated design elements to areas of the frame of user-provided image 108 that do not overlap (and potentially obfuscate) user-provided design elements.

A second placement objective guiding the placement of shapes within the graphics placement template 118 aims to concentrate the abstract shapes within specific subregion(s) of the defined frame that are designated by placement instruction(s) that the user has provided to the user interface 106. Therefore, in implementations where the parameter values 114 define one or more placement instructions, the placement of these abstract shapes is influenced by those placement instructions. For example, each user-specified placement instruction functions to select a corresponding subregion of the graphics placement template 118 that is to be populated by the abstract shapes. If the user has selected “top” as the placement instruction, a top subregion is selected within the frame of the graphics placement template 118, and abstract shapes are randomly seeded within this region (as generally described above).

In FIG. 1, it is assumed that the user provided a placement instruction designating “edges” of the frame for AI graphics generation. Consequently, the graphics placement template 118 in FIG. 1 illustrates abstract shapes concentrated around the edges of the frame. In other implementations where no placement instruction is specified (e.g., either because the user elects not to provide a placement instruction or because the user interface 106 does support this functionality), the composition augmenter 116 may autonomously select one or more subregions of the frame to be populated with the abstract shapes. Therefore, this subregion selection may be based on heuristics, rules, randomly set parameters, or some combination. For example, the composition augmenter 116 may select predefined subregions at random and/or based on a selection probability that is weighted to favor regions that do not overlap with user-provided design elements or that overlap “less” with the user-provided design elements than other subregions.

Random seeding of the abstract shapes is performed within the selected subregion(s) of the graphics placement template 118. The number of randomly seeded shapes in each selected subregion is, in one implementation, determined based on the value of the busyness parameter that the user has specified via the user interface 106 (e.g., among the parameter values 114). For example, the number of abstract shapes added to each image subregion is selected by a random number generator (RNG) that selects a number (identifying a number of shapes to place within a selected subregion) from a range of numbers that is fixed based on the value of the “busyness” parameter that the user has specified. If, for example, the user has selected a busyness parameter value indicative of a high degree of busyness, the RNG randomly selects the number of shapes from a larger selection pool than in scenarios where the user selects a busyness parameter value corresponding to a comparatively low degree of busyness. If, for example, the busyness parameter is a selectable integer between 0 and 20, with 20 indicating “maximum busyness”, the user's selection of ‘17’ for the busyness may cause the composition augmenter 116 to randomly select the number of shapes from a pool that includes integers 1 through 17 whereas the user's selection of ‘2’ for the busyness parameter may cause the composition augmenter 116 to randomly select the number of shapes from a selection pool that includes integers 1 and 2. In implementations where the user does not specify a value for a business parameter, the number of shapes in each selected subregion may be selected differently-such as randomly from a number pool of fixed size. The composition augmenter 116 may also assign a size to each abstract shape it creates. In different implementations, the size of each abstract shape can be selected in different ways, such as at random, according to a round-robin approach that ensures approximately equal selection of available shapes or other alternative selection methodologies.

In one implementation, the graphics placement template 2 is a two-tone greyscale image. The abstract shapes are generated using a single pixel value that is different from a single pixel value assigned to pixels representing empty space. For example, white (255) is used to denote pixels that do not belong to a corresponding one of the abstract shapes, while a shade of gray (e.g., 1-254) is used to denote pixels that are included in abstract shapes. The purpose of these two distinct pixel values is to denote areas that are and are not to be modified by the diffusion model 104.

To summarize the above, placement of the abstract shapes in the graphics placement template 118 is dictated, at least in part, by the user-provided placement instructions (if any are provided). Shape placement may also or alternatively be influenced by the locations of design elements within the user-provided image 108, such as per a selection methodology that is biased to reduce the likelihood of selecting subregion(s) that overlap more with user-provided design elements as compared to regions that overlap less with the user-provided design elements. The concentration of the abstract shapes within specific areas may be dictated, at least in part, by a “busyness” value that the user optionally specifies among the parameter values 114. Due to the manner in which inputs are passed to the diffusion model 104, the placement and density of these abstract shapes govern the placement and the “busyness” (e.g., concentration) of different design elements generated by the diffusion model 104.

Following the above-described operations, the graphics placement template 118 is provided to a noise infuser 120. The noise infuser 120 includes a noisy algorithm that adds Gaussian noise, in various colors, to regions of the graphics placement template 118 that include the abstract shapes. To do this, the algorithm selects a timestamp, “t,” which represents how much noise to add. Noise values ϵ are color values randomly sampled from a predefined color distribution, and the graphics placement template 118 is transformed into a noisy image 126 by adding noise step-by-step according to the diffusion equation:

xₜ=\sqrt{αₜ}x₀+\sqrt{1−αₜ}·ϵ

where x₀ is the original image, xₜ is the noisy version of the image at timestep t, αₜ is a scaling factor that controls how much of the original signal is preserved (and how fast colors spread throughout the noisy image), and ϵ represents random Gaussian noise sampled from a distribution of color values, which may be either a standard normal distribution of pixel values or a predefined distribution of color values, such as colors included in a user-defined color pallet.

Ultimately, the colors in the noisy image 126 serve to guide the diffusion model 104 in selecting colors to include in the AI-generated image 128. Due to the format of instructions and collection of inputs passed to the diffusion model 104 (described below), the diffusion model 104 tends to follow the colors used in the noisy image 126 when generating the AI-generated image 128, ensuring that these elements comply with the color scheme used within the noisy image. This helps to maintain coherence and visual appeal in the final design. Moreover, state-of-the-art diffusion models typically do a better job of “following” colors included in an image input than following text-based color instructions. This means that when a diffusion model is instructed to modify an input image without changing the image's color pallet, the diffusion model is more likely to preserve colors than it is to use the correct colors when otherwise explicitly instructed (via text-based instruction) to utilize certain colors (e.g., “use shades of maroon and aqua-marine”).

In one implementation, the user interface 106 provides the user with an option to select one or more colors to include in the AI-generated image 128. In this implementation, the parameter values 114 include the user's selection of color(s) and these colors dictate the pixel distribution that the noisy algorithm selects from when creating the noisy image 126. If, for example, the user selects “blue” and “grey,” then the noisy algorithm selects from a distribution of blues (e.g., 0 to 255 in the blue color channel with yellow and red channels set to 0) and greys (e.g., pixel values from 0 to 255 with identical R, G, and Y value components). Consequently, the noisy image 126 ultimately includes a selection of randomly selected pixel values that closely mimic or match the user's preferred color or color pallet. In this way, the colors of the AI-generated image 128 are directly controlled by the user.

After the noisy image 126 is created, a text prompt is created by a prompt generator 130. As inputs, the prompt generator 130 receives a subset of the parameter values 114 or other inputs (e.g., text instructions) that the user has provided to the user interface 106. For example, some implementations of the graphics design tool 102 allow the user to provide text-based instruction that describes aspects of the subject matter or design elements that the user desires for inclusion in the AI-generated graphics. This text-based instruction is passed to the prompt generator 130. Likewise, some implementations of the graphics design tool 102 allow the user to define other parameter values through the user interface 106 in addition to the parameters discussed above (e.g., placement instructions, busyness, and color). For instance, the user interface 106 may provide the user with an option to select a “style” or “theme” for the AI-generated image 128.

Based on these additional user-provided inputs to the user interface 106 that specify desired image characteristics (e.g., style, theme, text-based instructions describing subjects of interest or desired image characteristics), the prompt generator 130 generates an image modification instruction 133. The image modification instruction 133 directs the diffusion model 104 to modify the noisy image 126 to incorporate the desired imaged characteristics (e.g., specified within the parameter values 114 or other text-based instruction provided to the user interface 106). The image modification instruction 133 further directs the diffusion model to refrain from modifying regions of graphics placement template 118 that correspond to pixels of a defined value in the content mask 125 (e.g., the defined value is 0, representing black pixels, in implementations where the content mask 124 is a binary mask).

Assume, for example, that the parameter values 114 include a user-specified value “vintage” for a “style” parameter. In this case, the image modification instruction may include language such as: “Add vintage-style graphics to the input image, maintaining a botanical art style that is old fashioned and antique-looking with high details and muted colors. Do not modify any areas covered by black pixels in the mask. Preserve the original image details wherever the mask is black.”

The diffusion model 104 receives the set of inputs, including the image modification instruction 133, the noisy image 126, and the content mask 124, and begins processing the noisy image 126 according to the image modification instruction 133. The diffusion model 104 then outputs the AI-generated image 128, which is to be understood as an image with the same dimensions as the noisy image 126 (which, by design, is the same dimensions as the frame of the user-provided image 108).

The AI-generated image 128 is passed to a content synthesizer 132 that then merges together the AI-generated image 128 and the user-provided image 108 to generate the AI-augmented image 110. In one implementation, the content synthesizer 132 performs the merging by overlaying the user-provided image 108 on top of the AI-generated image 128. In other implementations, the merging entails other techniques such as frame averaging, panoramic stitching, multi-frame denoising, image blending, or other techniques readily known in the art.

The content synthesizer 132 presents the AI-augmented image 110 within the user interface 106 for and/or saves the AI-augmented image 110 to a local or remote storage location accessible to the graphics design tool 102 or other applications on the user device.

FIGS. 2A and 2B illustrate operations performed by an example graphics design tool 200 implementing the herein-disclosed technology for generating AI-augmented graphical content. The graphics design tool 200 includes many of the same components described with respect to the graphics design tool 102 of FIG. 1, and it is assumed that unless stated otherwise-the components in FIGS. 2A and 2B provide the same or similar functionality to the corresponding like-named components described with respect to FIG. 1. However, FIGS. 2A and 2B are included to illustrate an additional example of AI-augmented graphics generation.

FIG. 2A illustrates a first subset of operations for dynamically generating inputs to a diffusion model in response to receiving user-provided design elements that are to be included in an AI-augmented graphic (not shown). The graphics design tool 200 presents a user interface 206 within an application window that is rendered on a display of a user's computer system. Within the user interface 206, the user interacts with context creation tools to add stylized text 212 to a content window 209. The pixels within the content window 209—both corresponding to blank space and the stylized text—form an image that is referred to below as the user-provided image 208. When positioning the stylized text 212 in the content window 209, the user placed the text in left alignment on the bottom portion of the content window 209.

The user interacts with various controls on the user interface 206 to provide values for various input parameters that identify desired characteristics of to-be-generated AI graphical content. In this example, the user interacts with a drop-down menu 214 to provide a placement instruction that identifies a general region of the content window 209 where the user desires to add AI-generated graphical content. In the example shown, selectable values for the placement instruction include “edges,” “random,” “center,” “right,” “left,” “top,” and “bottom.” The user selects “top.”

The user also interacts with another drop-down menu 216 to designate a particular style for the AI-generated graphical content. From the drop-down menu 216, the user has selected a style 217 that is named “flat illustration.” Although not shown due to space limitations, it is contemplated that each selectable style is stored in association with a description that the user can access and read (e.g., by clicking on or hovering over a particular “style” on the drop-down menu 216) better understand the corresponding style and the type of content that the diffusion model is likely to create when a particular style is selected. For example, the style “flat illustration” may have a corresponding description that reads “A modern flat illustration design featuring bold, geometric shapes and vivid colors. The design should be minimalist and clean, with a focus on clarity and simplicity, employing minimal shading and a 2D graphic style for an uncluttered, contemporary look.”

Although not shown, other example selectable styles available in the drop-down menu 216 include styles such as: “Charcoal Sketch” (with a description that reads “sketchy looking hand drawn charcoal on paper style, looks like handmade sketches”), “Modern Illustration” (with a description that reads “modern vector illustration style), “Engraving” (with a description that reads “Linear engraving art style, high details, old school), Whimsical” (with a description that reads “Whimsical organic and flat illustration and abstract style), and more.

From a color selection menu 218, the user selects one or more preferred colors (a “color pallet”) for the AI-generated graphical content. In the example shown, the user selects “tan” and “pink.”

The user also interacts with a busyness parameter input box 220 to select an integer corresponding to a desired “busyness factor” of the to-be-generated AI graphical content. In this example, an integer data type is set for the busyness factor, and the user can select this value between 1 and 20, with 1 representing minimal busyness (e.g., visual complexity or density of design elements) and 20 representing maximal busyness. The user selects a busyness factor of 10.

The user-provided image 208 is passed to a mask generator 225, which, in turn, generates a content mask 224 corresponding to the user-provided image 208. In different implementations, the content mask 224 may be different types of masks. The content mask 224 includes image data within a frame that is of the same dimensions as the user-provided image 208. In one implementation, the content mask 224 is a binary mask that includes black pixel values (0) at locations within the frame that correspond to (e.g., overlap with) user-provided design elements (e.g., the stylized text 212) within the user-provided image 208. Within the binary mask, white pixel values (255) are included at locations that do not overlap with design elements present in the user-provided image 208. When subsequently provided to the diffusion model (not shown), a binary mask functions to instruct the diffusion model 104 to focus on pixel manipulations in regions that contain white pixels while leaving black pixel regions untouched.

In another implementation, the content mask 224 is a grayscale mask that uses shades of gray (1-254) in addition to black (255) and white (0). In addition to helping the diffusion model understand where to perform diffusion (and where not to), the grayscale mask additionally defines a degree of diffusion that is permitted in each region. Different pixel values in the greyscale mask function to modulate how strongly the diffusion model's generation is applied at each point in the AI-generated imagery that is generated, with increasingly darker shades of gray used to denote increasingly stronger localized diffusion (meaning more image modification).

In the example illustrated in FIGS. 2A-2B, the content mask 224 is a grayscale mask that includes grayscale gradients (e.g., gradients 235, 236) focused on different localized groupings of spatially distinct design elements in the user-provided image 208. Darker pixels appear near the centroid of each gradient 235, 236 with pixel color lightening in proportion to increased distance away from the centroid of each gradient. The purpose of this gradient approach is to ensure that the diffusion model does not make significant image alterations at locations overlapping the user-provided design elements (e.g., the stylized text 212) while still permitting the diffusion model to make minor modifications in these overlap regions. This gradient approach leads to smoother integration of the AI-generated and user-provided design elements. For example, this may ensure that the background behind the stylized text 212 blends seamlessly with the background that appears in surrounding areas. In contrast, using a binary mask to block off the stylized text 212 (e.g., by placing a solid black rectangle or oval in the region) can lead to scenarios where the background behind the stylized text 212 does not match the surrounding backdrop areas manipulated by the diffusion model.

The content mask 224 is provided as input to a composition augmenter 226, along with select parameter values that the user has specified interactions with the user interface. In this example, the composition augmenter 226 receives user-specified parameter values that include the placement instruction selected via the drop-down menu 214 (“Top”) and the Busyness factor that the user has input to the busyness parameter input box 220 (“10”).

Based on these inputs, the composition augmenter 226 creates a graphics placement template 228. The graphics placement template 228 is initialized as an empty image frame with dimensions identical to the content mask 224. The composition augmenter 226 then identifies a subregion of the empty image frame corresponding to the user-selected placement instruction. For example, each placement instruction selectable from the drop-down menu 214 has a predefined memory association with a continuous subregion of the frame. Thus, the user's selection of “top” from the drop-down menu 214 causes the composition augmenter 226 to select a top portion (e.g., top ½) of the graphics placement template 228 to receive graphical content.

The composition augmenter 226 then populates the selected subregion of the graphics placement template 228 with abstract shapes that have randomly selected forms and sizes. The number of abstract shapes added to the selected subregion is based, in part, on the busyness factor that the user has provided to the busyness parameter input box 220. A higher value for the busyness parameter results in a larger number of abstract shapes being added in the selected subregion.

In one implementation, the composition augmenter 226 divides the selected subregion (e.g., “top” part of the frame) into further smaller subregions and then randomly selects a number of shapes to add to each of these smaller subregions from a selection pool that is sized based on the busyness factor. For example, a busyness factor of “5” causes this random selection of the number of shapes to be selected from a pool including numbers 1-10, whereas a business level of “10” causes this random selection of the number of shapes to be selected from a pool including numbers 11-20.

The abstract shapes placed within the selected subregion (e.g., top portion) of the graphics placement template 228 are all defined by the same singular pixel value (e.g., a gray pixel). White pixels fill the empty space where no abstract shapes are added. Consequently, the graphics placement template 228 is, upon completion, a two-tone image with white pixels defining empty space and the other (singular, e.g., gray) pixel value defining the abstract shapes.

The graphics placement template 228 is input to a noise infuser 230. In this implementation, the noise infuser 230 additionally receives, as input, colors that the user has selected from the color selection menu 218. Based on these selected colors, the noise infuser 230 identifies a distribution of pixel values that is to be randomly sampled from by the noisy algorithm that adds Gaussian noise to the regions of the graphics placement template 228 that include the abstract shapes. For example, the subset of gray pixels (corresponding to the abstract shapes) collectively define the image data that is eligible to receive injections of noise, whereas the subset of white pixels (empty space) is not made available for noise injection. The noisy algorithm samples noise values ϵ (e.g., pixel values) from a predefined color distribution and injects these noise (color) values into the image data as generally described with respect to FIG. 1. In the example shown, the user has selected the colors “pink” and “tan.” Therefore, the predefined color distribution randomly sampled by the noisy algorithm is a distribution that includes various shades of pink and tan. The result of this processing is a noisy image 232.

FIG. 2B illustrates another subset of operations in the operation flow described with respect to FIG. 2A. The operations of FIG. 2B begin at the conclusion of operations discussed with respect to FIG. 2A. The content mask 224 and noisy image 232 are passed as input to a diffusion model 204. A prompt generator 234 then generates a text prompt, referred to below as image modification instruction 240, based on the style 217 (named “Flat Illustration”) that the user has selected from the user interface 206, as described with respect to FIG. 2A. It is assumed that the prompt generator 234 has access to the pre-written descriptions of each style that the user also has access to when selecting the style 217. The prompt generator 234 obtains the description corresponding to the style 217 and includes this description (either verbatim or with some modification) in the image modification instruction 240. Thus, in this example, the image modification instruction 240 reads:
“Add graphics to the input image that adhere to a modern flat illustration style featuring bold, geometric shapes and vivid colors. The design should be minimalist and clean, with a focus on clarity and simplicity, employing minimal shading and a 2D graphic style for an uncluttered, contemporary look. Use the mask to determine the degree of modification permitted in each area of the image. The degree of modification in each area of the image is dependent upon pixel values in corresponding areas of the mask, with permissible modifications decreasing in proportion to increasing pixel value. Do not modify areas of the image covered by black pixels in the mask. Preserve the original image details wherever the mask is black.”

The prompt generator 234 passes the diffusion model 204 the image modification instruction 240, and the diffusion model 204 modifies the noisy image 232 according to the image modification instruction 240, using the content mask 224 to identify how much modification is permitted and where.

At the conclusion of this processing, the diffusion model 204 outputs an AI-generated image 242, which has dimensions equal to the noisy image 232 and content mask 224. The image includes AI-generated design elements (graphics) in the region corresponding to the color-infused region (e.g., containing all of the non-white pixels) in the noisy image 232. These AI-generated design elements reflect the style 217 that was selected by the user and include colors that generally match (e.g., from the same color pallet) the colors in the noisy image 232. This color matching is due to the image modification methodology employed by the diffusion model 204 (e.g., absent contrary instructions, the model modifies the starting image using the same color tones that appear in the starting image).

A content synthesizer 244 merges the AI-generated image 242 with the user-provided image 208 to create an AI-augmented image 246, which includes the AI-generated design elements at the same positions as in the AI-generated image 242 and the user-provided design elements at the same positions as in the user-provided image 208. The AI-augmented image 246 is presented on the user interface 206 and/or stored by the graphics design tool 200 in a location readily accessible to the user at a later point in time.

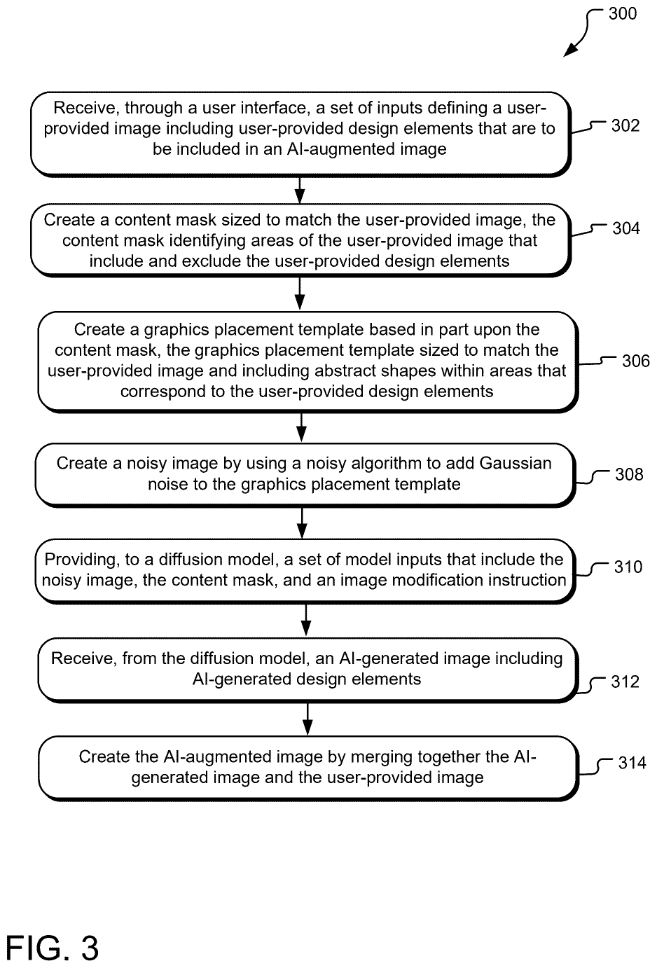

FIG. 3 illustrates example operations 300 for employing the herein-disclosed technology to generate an AI-augmented image dynamically in response to user inputs. An input receipt operation 302 receives a set of inputs through a user interface. The set of inputs define a user-provided image that includes user-provided design elements that are to be included in the AI-augmented image. In one implementation, the user-provided image is created by a user by interacting with tools available within the user interface. In other implementations, the user-provided image is imported into the user interface.

A content mask creation operation 304 creates a content mask that is sized to match (meaning-has the same dimensions as) the user-provided image. The content mask identifies areas of the user-provided image that respectively include and exclude the user-provided design elements. For example, the content mask includes white pixels that denote empty space and black pixels (or greyscale pixels of various tones) that denote locations of the user-provided design elements.

A graphics placement template creation operation 306 creates a graphics placement template based, at least in part, upon the content mask or the user-provided image. The graphics placement template is sized to match the user-provided image and includes abstract shapes within areas that spatially correspond to the user-provided design elements. The graphics placement template serves as a template that identifies regions where AI-generate graphics are to be inserted-specifically, the locations that include the abstract shapes. This template can be generated based on the content mask (e.g., excluding abstract shapes in the masked areas corresponding to user-provided design elements), a placement instruction received through the user interface (e.g., an instruction that selects a frame subregion to receive AI-generated design elements), or otherwise from the user-provided image (e.g., using alternative methodology to position the abstract shapes in areas that do not overlap with the user-provided design elements in the user-provided image).

A noisy image creation operation 308 processes the graphics placement template with a noisy algorithm to transform the graphics placement template into a noisy image. This entails randomly injecting noise (pixel values corresponding to different colors) in the regions corresponding to the abstract shapes while leaving empty areas of the graphics placement template untouched.

A model input preparation 310 prepares a set of model inputs and provides those inputs to a diffusion model. The set of model inputs includes the noisy image, the content mask, and an image modification instruction. A receiving operation 312 receives, from the diffusion model, an AI-generated image that includes AI-generated design elements. The AI-generated image has a size matching the user-provided image and the noisy image. The AI-generated design elements are included in areas corresponding to the “noise” (e.g., non-white pixels) of the noisy image.

A composite image creation operation 314 creates the AI-augmented image as a composite of the AI-generated image and the user-provided image. For example, the images are merged together (e.g., pixels added). Due to the methodology used to dynamically create the AI-generated image, the AI-generated design elements are positioned in areas that largely correspond to blank space included in the user-provided image. Thus, there is very limited or substantially no overlap between the AI-generate design elements and the user-provided design elements.

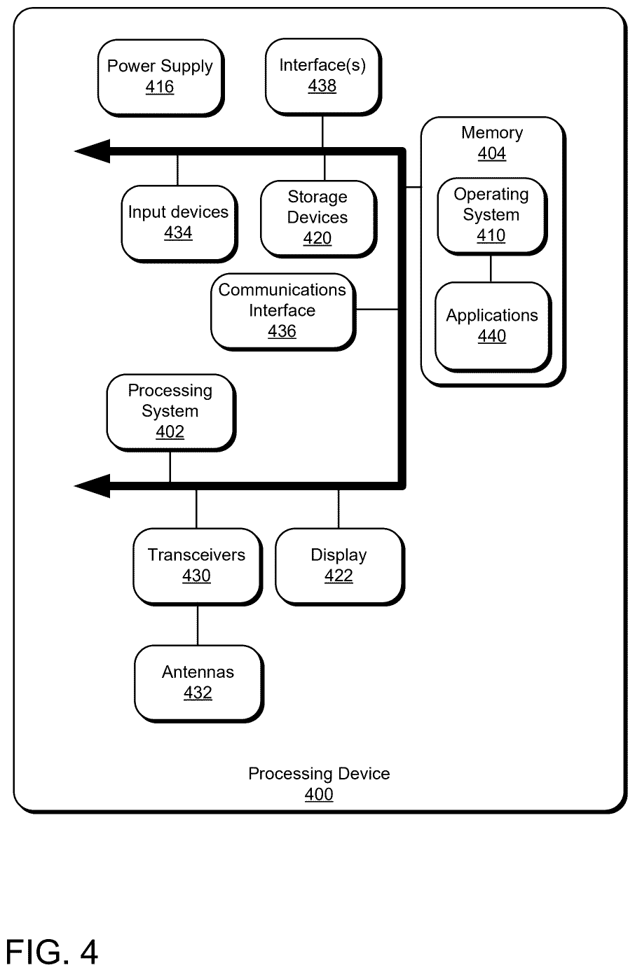

FIG. 4 illustrates an example computing device 400 for use in implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes a processing system 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processing system 402. In some implementations, the computing device 400 includes and/or is communicatively coupled to storage 420.

In the example computing device 470 one or more software modules, segments, and/or processors, such as applications 450 (e.g., the graphics design tool 102 of FIG. 1, a subcomponent of the graphics design tool 102 of FIG. 1, or the diffusion model 104 of FIG. 1) are loaded into the memory 404 by the operating system 410 and executed by the processor(s) 472. The storage 420 may store mixed-precision test configurations, saliency metrics, saliency rankings, and recommended mixed-precision data type configurations generated by the herein-disclosed technology.

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a system including: memory; a processing system; control logic stored in the memory that, when executed by the processing system presents a user interface on a display, the user interface configured to receive a set of user inputs, the set of user inputs including a user-provided image including user-provided design elements that are be included in an AI-augmented image; a mask generator stored in the memory that, when executed by the processing system, creates a content mask that masks areas of the user-provided image that include the user-provided design elements; a composition augmenter stored in the memory that, when executed by the processing system, is configured to use the content mask to create a graphics placement template, the graphics placement template including abstract shapes in regions corresponding to unmasked areas in the content mask; a noise infuser stored in the memory that, when executed by the processing system, creates a noisy image by adding Gaussian noise to the graphics placement template; a prompt generator stored in the memory that, when executed by the processing system, is configured to: generate a set of model inputs including the noisy image, the content mask, and an image modification instruction; and provide the set of model inputs to a diffusion model; a content synthesizer stored in the memory that, when executed by the processing system, is configured to receive AI-generated design elements as output from the diffusion model based on processing of the set of model inputs and merge the AI-generated design elements with the user-provided image to create the AI-augmented image.

In some aspects, the techniques described herein relate to a system, wherein the user interface is further configured to receive user inputs that identify a desired characteristic of AI-generated design elements, and wherein the image modification instruction identifies the desired characteristic.

In some aspects, the techniques described herein relate to a system, wherein the set of user inputs received at the user interface includes a placement instruction indicating a subregion of the AI-augmented image that is to include the AI-generated design elements, and wherein the composition augmenter randomly places the abstract shapes within the subregion of the graphics placement template that is indicated by the placement instruction.

In some aspects, the techniques described herein relate to a system, wherein the set of user inputs received at the user interface identify one or more colors to be included in the AI-augmented image, and wherein the noise infuser selects a distribution of pixels for random sampling operations of a noisy algorithm based on the one or more colors.

In some aspects, the techniques described herein relate to a system, wherein the set of user inputs received at the user interface further include a busyness factor that quantifies a desired level of complexity or density of design elements included in the AI-augmented image, and wherein a total number of the abstract shapes randomly placed in the graphics placement template is determined, at least in part, based on the busyness factor.

In some aspects, the techniques described herein relate to a system, wherein the user-provided image includes some empty space in addition to the user-provided design elements, and wherein the content mask is a greyscale mask that defines a gradient with values that decrease in proportion to increased distance from the user-provided design elements.

In some aspects, the techniques described herein relate to a system, wherein the graphics placement template and the content mask are dynamically created in response to receipt of the set of user inputs.

In some aspects, the techniques described herein relate to a system, wherein the set of user inputs received at the user interface includes identifies a user-selected style that is identified or described in the image modification instruction.

In some aspects, the techniques described herein relate to a method including: receiving through a user interface on a display a user-provided image including user-provided design elements that are to be included in an AI-augmented image; creating a content mask sized to match the user-provided image, the content mask identifying areas of the user-provided image that include and exclude the user-provided design elements; creating a graphics placement template based in part upon the content mask, the graphics placement template sized to match the user-provided image and including abstract shapes within areas of a frame that do correspond to the user-provided design elements; creating a noisy image by using a noisy algorithm to add Gaussian noise to the graphics placement template; providing, to a diffusion model, a set of model inputs that include the noisy image, the content mask, and an image modification instruction; receiving, from the diffusion model, an AI-generated image including AI-generated design elements; and creating the AI-augmented image by merging the AI-generated image with the user-provided image.

In some aspects, the techniques described herein relate to a method, further including: receiving through the user interface a user input that identifies a desired characteristic of AI-generated design elements, and wherein the image modification instruction identifies the desired characteristic.

In some aspects, the techniques described herein relate to a method, further including: receiving through the user interface a placement instruction indicating a subregion of the AI-augmented image that is to include the AI-generated design elements and randomly placing the abstract shapes within the subregion of the graphics placement template that is indicated by the placement instruction.

In some aspects, the techniques described herein relate to a method, further including: receiving through the user interface one or more colors to be included in the AI-augmented image, and wherein creating the noisy image includes injecting noise by random sampling from a distribution of pixels defined based on the one or more colors.

In some aspects, the techniques described herein relate to a method, further including: receiving through the user interface a busyness factor that quantifies a desired level of complexity or density of design elements included in the AI-augmented image, and wherein a total number of the abstract shapes randomly placed in the graphics placement template is determined, at least in part, based on the busyness factor.

In some aspects, the techniques described herein relate to a method, wherein the user-provided image includes some empty space in addition to the user-provided design elements, and wherein the content mask is a greyscale mask that defines a gradient with values that decrease in proportion to increased distance from the user-provided design elements.

In some aspects, the techniques described herein relate to a method, wherein the graphics placement template and the content mask are dynamically created in response to user interactions with the user interface.

In some aspects, the techniques described herein relate to a method, further including: receiving through the user interface a user-selected style that is identified or described in the image modification instruction.

In some aspects, the techniques described herein relate to one or more tangible computer-readable storage media encoding processor-executable instructions for executing a computer process, the computer process including: receiving a set of inputs through a user interface, the set of inputs including: a user-provided image including user-provided design elements that are to be included in an AI-augmented image; and a placement instruction identifying a subregion of the user-provided image where AI-generated design elements are to be added; creating a content mask sized to match the user-provided image, the content mask identifying areas of the user-provided image that include and exclude the user-provided design elements; creating a graphics placement template based in part on the placement instruction, the graphics placement template sized to match the user-provided image and including abstract shapes within an area corresponding to the subregion identified by the placement instruction; creating a noisy image by using a noisy algorithm to add colorful Gaussian noise to the graphics placement template; providing, to a diffusion model, a set of model inputs that include the noisy image, the content mask, and an image modification instruction; receiving, from the diffusion model, an AI-generated image including AI-generated content items; creating the AI-augmented image by merging the AI-generated image with the user-provided image.

In some aspects, the techniques described herein relate to one or more tangible computer-readable storage media, wherein the set of inputs further includes at least one input describing a desired characteristic of the AI-generated design elements, and wherein the image modification instruction specifies the desired characteristic.

In some aspects, the techniques described herein relate to one or more tangible computer-readable storage media, wherein the set of inputs includes a designation of one or more colors to be used in generating the AI-generated design elements, and wherein creating the noisy image includes injecting noise by random sampling from a distribution of pixels defined based on the one or more colors.

In some aspects, the techniques described herein relate to one or more tangible computer-readable storage media, wherein the set of inputs includes a busyness factor that quantifies a desired level of complexity or density of design elements included in the AI-augmented image, and wherein a total number of the abstract shapes randomly placed in the graphics placement template is determined, at least in part, based on the busyness factor. The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order unless explicitly claimed otherwise or a specific order is inherently necessitated by the claim language. The above specification, examples, and data, together with the attached appendices, provide a complete description of the structure and use of example implementations.

What is claimed is:

1. A system comprising:
memory;
a processing system;
control logic stored in the memory that, when executed by the processing system presents a user interface on a display, the user interface configured to receive a set of user inputs, the set of user inputs including a user-provided image including user-provided design elements that are be included in an AI-augmented image;
a mask generator stored in the memory that, when executed by the processing system, creates a content mask that masks areas of the user-provided image that include the user-provided design elements;
a composition augmenter stored in the memory that, when executed by the processing system, is configured to use the content mask to create a graphics placement template, the graphics placement template including abstract shapes in regions corresponding to unmasked areas in the content mask;
a noise infuser stored in the memory that, when executed by the processing system, creates a noisy image by adding Gaussian noise to the graphics placement template;
a prompt generator stored in the memory that, when executed by the processing system, is configured to:
generate a set of model inputs including the noisy image, the content mask, and an image modification instruction; and
provide the set of model inputs to a diffusion model;
a content synthesizer stored in the memory that, when executed by the processing system, is configured to receive AI-generated design elements as output from the diffusion model based on processing of the set of model inputs and merge the AI-generated design elements with the user-provided image to create the AI-augmented image.

2. The system of claim 1, wherein the user interface is further configured to receive user inputs that identify a desired characteristic of AI-generated design elements, and wherein the image modification instruction identifies the desired characteristic.

3. The system of claim 1, wherein the set of user inputs received at the user interface includes a placement instruction indicating a subregion of the AI-augmented image that is to include the AI-generated design elements, and wherein the composition augmenter randomly places the abstract shapes within the subregion of the graphics placement template that is indicated by the placement instruction.

4. The system of claim 1, wherein the set of user inputs received at the user interface identify one or more colors to be included in the AI-augmented image, and wherein the noise infuser selects a distribution of pixels for random sampling operations of a noisy algorithm based on the one or more colors.

5. The system of claim 1, wherein the set of user inputs received at the user interface further include a busyness factor that quantifies a desired level of complexity or density of design elements included in the AI-augmented image, and wherein a total number of the abstract shapes randomly placed in the graphics placement template is determined, at least in part, based on the busyness factor.

6. The system of claim 1, wherein the user-provided image includes some empty space in addition to the user-provided design elements, and wherein the content mask is a greyscale mask that defines a gradient with values that decrease in proportion to increased distance from the user-provided design elements.

7. The system of claim 1, wherein the graphics placement template and the content mask are dynamically created in response to receipt of the set of user inputs.

8. The system of claim 1, wherein the set of user inputs received at the user interface includes identifies a user-selected style that is identified or described in the image modification instruction.

9. A method comprising:
receiving through a user interface on a display a user-provided image including user-provided design elements that are to be included in an AI-augmented image;
creating a content mask sized to match the user-provided image, the content mask identifying areas of the user-provided image that include and exclude the user-provided design elements;
creating a graphics placement template based in part upon the content mask, the graphics placement template sized to match the user-provided image and including abstract shapes within areas of a frame that do correspond to the user-provided design elements;
creating a noisy image by using a noisy algorithm to add Gaussian noise to the graphics placement template;
providing, to a diffusion model, a set of model inputs that include the noisy image, the content mask, and an image modification instruction;
receiving, from the diffusion model, an AI-generated image including AI-generated design elements; and
creating the AI-augmented image by merging the AI-generated image with the user-provided image.

10. The method of claim 9, further comprising:
receiving through the user interface a user input that identifies a desired characteristic of AI-generated design elements, and wherein the image modification instruction identifies the desired characteristic.

11. The method of claim 9, further comprising:
receiving through the user interface a placement instruction indicating a subregion of the AI-augmented image that is to include the AI-generated design elements and randomly placing the abstract shapes within the subregion of the graphics placement template that is indicated by the placement instruction.

12. The method of claim 9, further comprising:
receiving through the user interface one or more colors to be included in the AI-augmented image, and wherein creating the noisy image includes injecting noise by random sampling from a distribution of pixels defined based on the one or more colors.

13. The method of claim 9, further comprising:
receiving through the user interface a busyness factor that quantifies a desired level of complexity or density of design elements included in the AI-augmented image, and wherein a total number of the abstract shapes randomly placed in the graphics placement template is determined, at least in part, based on the busyness factor.

14. The method of claim 9, wherein the user-provided image includes some empty space in addition to the user-provided design elements, and wherein the content mask is a greyscale mask that defines a gradient with values that decrease in proportion to increased distance from the user-provided design elements.

15. The method of claim 9, wherein the graphics placement template and the content mask are dynamically created in response to user interactions with the user interface.

16. The method of claim 9, further comprising:
receiving through the user interface a user-selected style that is identified or described in the image modification instruction.

17. One or more tangible computer-readable storage media encoding processor-executable instructions for executing a computer process, the computer process comprising:
receiving a set of inputs through a user interface, the set of inputs including:
a user-provided image including user-provided design elements that are to be included in an AI-augmented image; and
a placement instruction identifying a subregion of the user-provided image where AI-generated design elements are to be added;
creating a content mask sized to match the user-provided image, the content mask identifying areas of the user-provided image that include and exclude the user-provided design elements;
creating a graphics placement template based in part on the placement instruction, the graphics placement template sized to match the user-provided image and including abstract shapes within an area corresponding to the subregion identified by the placement instruction;
creating a noisy image by using a noisy algorithm to add colorful Gaussian noise to the graphics placement template;
providing, to a diffusion model, a set of model inputs that include the noisy image, the content mask, and an image modification instruction;
receiving, from the diffusion model, an AI-generated image including AI-generated content items;
creating the AI-augmented image by merging the AI-generated image with the user-provided image.

18. The one or more tangible computer-readable storage media of claim 17, wherein the set of inputs further comprises at least one input describing a desired characteristic of the AI-generated design elements, and wherein the image modification instruction specifies the desired characteristic.

19. The one or more tangible computer-readable storage media of claim 17, wherein the set of inputs includes a designation of one or more colors to be used in generating the AI-generated design elements, and wherein creating the noisy image includes injecting noise by random sampling from a distribution of pixels defined based on the one or more colors.

20. The one or more tangible computer-readable storage media of claim 17, wherein the set of inputs includes a busyness factor that quantifies a desired level of complexity or density of design elements included in the AI-augmented image, and wherein a total number of the abstract shapes randomly placed in the graphics placement template is determined, at least in part, based on the busyness factor.
